(19) United States
(12) Patent Application Publication
(10) Pub. No.: US 2026/0045497 A1
(43) Pub. Date: Feb. 12, 2026

(54) POSITIVE ELECTRODE ACTIVE MATERIAL AND ALL SOLID BATTERY

(71) Applicant: TAIYO YUDEN CO., LTD., Tokyo (JP)

(72) Inventor: Yusuke KAWASAKI, Takasaki-shi (JP)

(21) Appl. No.: 19/268,622

(22) Filed: Jul. 14, 2025

(30) Foreign Application Priority Data
Aug. 6, 2024 (JP) 2024-130004

(51) Int. Cl. H01M 4/58; C01B 25/45; H01M 4/02; H01M 4/136; H01M 4/62; H01M 10/0562; H01M 10/0585

(52) U.S. Cl. CPC H01M 4/5825; C01B 25/45; H01M 4/136; H01M 4/62; H01M 10/0562; H01M 10/0585; C01P 2002/54; C01P 2004/61; C01P 2004/62; C01P 2006/40; H01M 2004/021; H01M 2004/028; H01M 2300/0071

(57) ABSTRACT

A positive electrode active material includes an alkali metal phosphate containing Co. Si is solid-solved in the phosphate.

### CROSS-REFERENCE TO RELATED APPLICATION

This application is based upon and claims the benefit of priority of the prior Japanese Patent Application No. 2024-130004, filed on Aug. 6, 2024, the entire contents of which are incorporated herein by reference.

### FIELD

A certain aspect of the present invention relates to a positive electrode active material and an all solid battery.

### BACKGROUND

In recent years, secondary batteries have been used in a variety of fields. Secondary batteries that use an electrolyte have problems such as electrolyte leakage. Therefore, development is being carried out on all solid batteries that have a solid electrolyte and other components that are also solid. For example, an integrated sintered all solid battery that uses LiCoPO₄ as a positive electrode active material has been disclosed (see, for example, Japanese Patent Application Publication No. 2023-41135, Japanese Patent Application Publication No. 2023-33799 and Japanese Patent Application Publication No. 2008-506243).

### SUMMARY OF THE INVENTION

According to an aspect of the present invention, there is provided a positive electrode active material including: an alkali metal phosphate containing Co, wherein Si is solid-solved in the phosphate.

According to an aspect of the present invention, there is provided a positive electrode active material including: an alkali metal phosphate containing Co, wherein, when the phosphate is analyzed by XRD, a peak of a substance expressed by a general formula M_{1-y}Co_{1-x+y}M′ₓPO₄ (0≤x≤1, 0<y<1) appears, wherein M is an alkali metal, and wherein M′ is at least one element selected from Mg, Fe, Mn, Zn, or Ni.

According to an aspect of the present invention, there is provided an all solid battery including: a positive electrode layer including one of the above-mentioned positive electrode active materials, a negative electrode layer, and a solid electrolyte layer between the positive electrode layer and the negative electrode layer.

### BRIEF DESCRIPTION OF THE DRAWINGS

FIG. 1 illustrates a schematic cross section of a basic structure of an all solid battery;

FIG. 2 illustrates a schematic cross section indicating details of a positive electrode layer and a negative electrode layer;

FIG. 3 illustrates a schematic cross section of a stacked all solid battery;

FIG. 4 illustrates a schematic cross section of another stacked all solid battery;

FIG. 5 illustrates a flowchart of a manufacturing method of an all solid battery;

FIG. 6A and FIG. 6B illustrate a stacking process; and

FIG. 7 illustrates measured results of cycle characteristics.

### DETAILED DESCRIPTION

All solid batteries are required to have excellent cycle characteristics. However, the charge/discharge cycle of all solid batteries may deteriorate.

A description will be given of an embodiment with reference to the accompanying drawings.

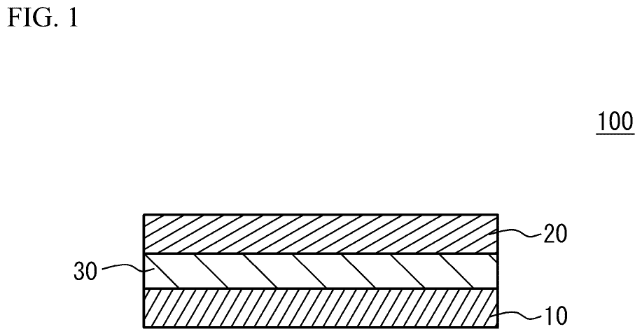

(Embodiment) FIG. 1 illustrates a schematic cross section of a basic structure of an all solid battery 100 in accordance with an embodiment. As illustrated in FIG. 1, the all solid battery 100 has a structure in which a first internal electrode 10 and a second internal electrode 20 sandwich a solid electrolyte layer 30. The first internal electrode 10 is provided on a first main face of the solid electrolyte layer 30. The second internal electrode 20 is provided on a second main face of the solid electrolyte layer 30. For example, the first internal electrode 10, the second internal electrode 20 and the solid electrolyte layer 30 have a sintered body which is formed by sintering powder materials.

When the all solid battery 100 is used as a secondary battery, one of the first internal electrode 10 and the second internal electrode 20 is used as a positive electrode, and the other is used as a negative electrode. In this embodiment, as an example, the first internal electrode 10 is used as a positive electrode, and the second internal electrode 20 is used as a negative electrode.

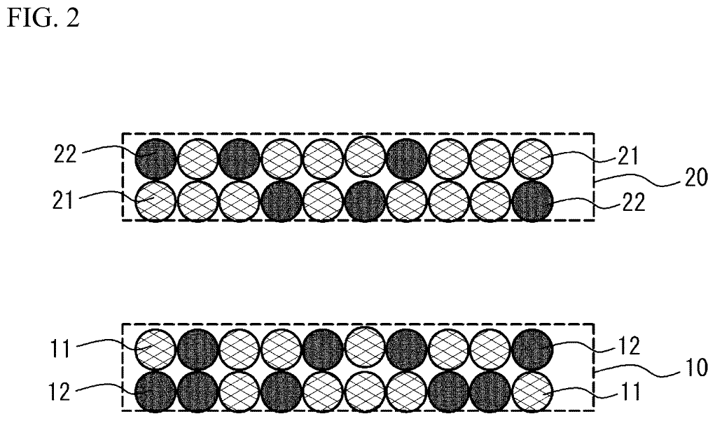

FIG. 2 illustrates the details of the cross section of the first internal electrode 10 and the second internal electrode 20. As illustrated in FIG. 2, the first internal electrode 10 has a structure in which grains of positive electrode active materials 11 and grains of solid electrolytes 12 are dispersed and sintered. The first internal electrode 10 may include a conductive auxiliary agent in addition to the positive electrode active material 11 and the solid electrolyte 12. The second internal electrode 20 has a structure in which grains of negative electrode active materials 21 and grains of solid electrolytes 22 are dispersed and sintered. The second internal electrode 20 may include a conductive auxiliary agent in addition to the negative electrode active material 21 and the solid electrolyte 22. The first internal electrode 10 includes the positive electrode active material 11, and the second internal electrode 20 includes the negative electrode active material 21, so that the all solid battery 100 can be used as a secondary battery. The first internal electrode 10 includes the solid electrolyte 12, and the second internal electrode 20 includes the solid electrolyte 22, so that the first internal electrode 10 and the second internal electrode 20 have ionic conductivity. The first internal electrode 10 and the second internal electrode 20 have a conductive auxiliary agent, so that the first internal electrode 10 and the second internal electrode 20 have conductivity.

A main component of the solid electrolyte layer 30 is a solid electrolyte having ionic conductivity. The solid electrolyte of the solid electrolyte layer 30 is an oxide-based solid electrolyte having lithium ion conductivity. The solid electrolyte is, for example, phosphate-based electrolyte having a NASICON crystal structure. For example, the solid electrolyte of the solid electrolyte layer 30 is oxide-based solid electrolyte having lithium ion conductivity. The phosphate is not limited. For example, the phosphate is such as composite salt of phosphate with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphate is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, the phosphate may be a Li—Al—Co—Ge—PO₄-based material to which Co has been added in advance, similar to the Co-containing phosphate-based solid electrolyte contained in the first internal electrode 10 used as the positive electrode, but the phosphate may not necessarily contain Co.

Solid electrolytes are flame-retardant or non-flammable, and are inherently safer than flammable organic liquid electrolyte. In particular, oxide-based solid electrolytes, which exhibit high ionic conductivity through sintering, have the advantage of having a wider potential window than electrolyte systems and other solid electrolyte systems, and being relatively stable in the atmosphere. In particular, phosphate-based solid electrolytes with a NASICON structure are oxide-based solid electrolytes that have a wider potential window on the high-potential side and are highly stable in the atmosphere.

The thickness of the solid electrolyte layer 30 is, for example, 0.5 μm or more and 30 μm or less, 1 μm or more and 20 μm or less, or 2 μm or more and 10 μm or less.

Here, the positive electrode active material of the first internal electrode 10 will be considered. The positive electrode active material is preferably a material that is unlikely to undergo a chemical reaction with the solid electrolyte even when sintered at high temperatures. Therefore, it is considered to use an alkali metal phosphate containing Co as the positive electrode active material. For example, LiCoPO₄, NaCoPO₄, or the like can be used as the positive electrode active material. However, since the volume change of alkali metal phosphate containing Co is large during charging and discharging, there is a risk that excellent cycle characteristics may not be obtained. Therefore, the all solid battery 100 according to this embodiment has a configuration that can realize high cycle characteristics. Details will be described below.

The inventor has investigated a configuration in which volume change during charging and discharging can be suppressed and deterioration of cycle characteristics can be suppressed in an alkali metal phosphate containing Co. Through intensive research by the inventor, it has been found that in a phosphate-based positive electrode active material containing a transition metal element, by replacing a part of P (phosphorus) with another element to form a solid solution, the change in crystal structure during charging and discharging can be suppressed, and cycle deterioration of an all solid battery can be suppressed. For example, it has been found that by using an active material in which an alkali metal phosphate containing Co is used as the positive electrode active material 11 and a part of the P site is replaced with Si (silicon), the change in crystal structure during charging and discharging is smaller than when Si is not solid-solved in the solid solution, and excellent cycle characteristics can be realized.

Therefore, a positive electrode active material of an alkali metal phosphate containing Co, in which Si is solid-solved in the solid solution, is used as the positive electrode active material 11. This makes it possible to realize excellent cycle characteristics.

Furthermore, it has been found that by substituting the Co site in an alkali metal phosphate containing Co with another element, the volume change during charging and discharging is suppressed, and the deterioration of the cycle characteristics of the all solid battery is suppressed. Therefore, it is preferable to use an active material as the positive electrode active material 11, which is an alkali metal phosphate containing Co, in which Si is solid-solved and part of the Co site is substituted with at least one of Mg, Fe, Mn, Zn, or Ni.

The positive electrode active material 11 has, for example, a general formula M_{1-y}Co_{1-x+y}M′ₓP_{1-y}Si_{y}O₄ (0≤x≤1, 0<y<1), where M is at least one element of alkali metal elements such as Li (lithium) or Na (sodium), and M′ is at least one element of Mg (magnesium), Fe (iron), Mn (manganese), Zn (zinc), or Ni (nickel), and has an olivine structure. As an example, the positive electrode active material 11 is Li_{0.97}Co_{1.03}P_{0.97}Si_{0.03}O₄, Li_{0.98}Co_{1.02}P_{0.98}Si_{0.02}O₄, Li_{0.98}Co_{0.82}Ni_{0.2}P_{0.98}Si_{0.02}O₄, Li_{0.97}Co_{0.88}Ni_{0.15}P_{0.97}Si_{0.03}O₄, or the like. In addition, when multiple elements are used as the above M, the composition ratio “1-y” of M_{1-y} means the composition ratio of the total amount of the multiple elements. In the case where multiple elements are used as the above M′, the composition ratio “x” of M′x means the composition ratio of the total amount of the multiple elements.

For example, when the positive electrode active material 11 is analyzed by XRD (X-ray diffraction), a peak of a substance represented by the above general formula M_{1-y}Co_{1-x+y}M′ₓPO₄ (0≤x≤1, 0<y<1) appears. In addition, by performing Rietveld analysis, it is possible to infer that a part of the P site is substituted with Si.

From the viewpoint of sufficiently improving the cycle characteristics, it is preferable to set a lower limit for the amount of Si in solid solution. In this embodiment, in M_{1-y}Co_{1-x+y}M′ₓP_{1-y}Si_{y}O₄, it is preferable that 0.01≤y, more preferably 0.015≤y, and even more preferably 0.02≤ y.

If the amount of Si in solid solution is large, there is a risk that the battery capacity will decrease. Therefore, it is preferable to set an upper limit for the amount of Si in solid solution. In this embodiment, in M_{1-y}CO_{1-x+y}M′ₓP_{1-y}Si_{y}O₄, it is preferable that 0<y≤0.1, more preferably 0<y≤0.05, and even more preferably 0<y≤0.04.

If the amount of substitution of the Co site in M_{1-y}CO_{1-x+y}M′ₓP_{1-y}Si_{y}O₄ is large, the charge/discharge capacity may decrease, so it is preferable that 0<x≤0.5, and more preferably 0<x≤0.3. When x≤0.3, excellent characteristics are obtained in both charge/discharge capacity and cycle characteristics.

If ab average grain size of the positive electrode active material 11 in the first internal electrode 10 is small, there is a risk of a side reaction progressing during co-sintering with the solid electrolyte. Therefore, it is preferable to set a lower limit on the average grain size of the positive electrode active material 11. In this embodiment, the average grain size of the positive electrode active material 11 is preferably 0.05 μm or more, more preferably 0.08 μm or more, and even more preferably 0.10 μm or more.

On the other hand, if the average grain size of the positive electrode active material 11 in the first internal electrode 10 is large, there is a risk of an increase in overvoltage during discharge. Therefore, it is preferable to set an upper limit on the average grain size of the positive electrode active material 11. In this embodiment, the average grain size of the positive electrode active material 11 is preferably 5.00 μm or less, more preferably 1.00 μm or less, and even more preferably 0.50 μm or less.

If the content of the positive electrode active material 11 in the first internal electrode 10 is small, there is a risk of a decrease in the volumetric capacity density of the positive electrode. Therefore, it is preferable to set a lower limit on the content of the positive electrode active material 11. In this embodiment, an area occupancy ratio of the positive electrode active material 11 in the cross section of the first internal electrode 10 is preferably 40% or more, more preferably 45% or more, and even more preferably 50% or more.

If the content of the positive electrode active material 11 in the first internal electrode 10 is high, the operating rate of the active material during charging and discharging may decrease. Therefore, it is preferable to set an upper limit on the content of the positive electrode active material 11. In this embodiment, the area occupancy ratio of the positive electrode active material 11 in the cross section of the first internal electrode 10 is preferably 75% or less, more preferably 70% or less, and even more preferably 65% or less.

The solid electrolyte 12 provided in the first internal electrode 10 is not particularly limited, but is preferably a phosphate-based solid electrolyte having a NASICON structure. This is because phosphate-based solid electrolytes having a NASICON structure have the properties of a wide potential window on the high potential side and high atmospheric stability. Even if a phosphate-based solid electrolyte having a NASICON structure is used as the solid electrolyte 12, since the positive electrode active material 11 is a phosphate containing Co, the chemical reaction between the positive electrode active material 11 and the solid electrolyte 12 during sintering can be suppressed. The solid electrolyte 12 may be, for example, the same as the main component solid electrolyte of the solid electrolyte layer 30.

If the average grain size of the solid electrolyte 12 in the first internal electrode 10 is small, the dispersion state of the electrode paste before firing becomes unstable, making it difficult to obtain a dense coating film, and the reactivity during heat treatment of the all solid battery 100 increases, making it easier for interdiffusion reactions to occur, which is not preferable. Therefore, it is preferable to set a lower limit for the average grain size of the solid electrolyte 12 in the first internal electrode 10. In this embodiment, the average grain size of the solid electrolyte 12 in the first internal electrode 10 is preferably 0.1 μm or more, more preferably 0.2 μm or more, and even more preferably 0.3 μm or more.

On the other hand, if the average grain size of the solid electrolyte 12 in the first internal electrode 10 is large, it is not preferable because a high temperature is required for sintering and densification. Therefore, it is preferable to set an upper limit on the average grain size of the solid electrolyte 12 in the first internal electrode 10. In this embodiment, the average grain size of the solid electrolyte 12 in the first internal electrode 10 is preferably 10.0 μm or less, more preferably 7.0 μm or less, and even more preferably 5.0 μm or less.

If the content of the solid electrolyte 12 in the first internal electrode 10 is small, it is not preferable because the ion conduction path is not secured and the internal resistance becomes high. Therefore, it is preferable to set a lower limit on the content of the solid electrolyte 12. In this embodiment, the area occupancy ratio of the solid electrolyte 12 in the cross section of the first internal electrode 10 is preferably 15% or more, more preferably 20% or more, and even more preferably 25% or more.

In the first internal electrode 10, if the content of the solid electrolyte 12 is high, the capacity decreases because the amount of active material filled is not increased. Therefore, it is preferable to set an upper limit on the content of the solid electrolyte 12. In this embodiment, the area occupied by the solid electrolyte 12 in the cross section of the first internal electrode 10 is preferably 75% or less, more preferably 70% or less, and even more preferably 65% or less.

The thickness of each first internal electrode 10 is, for example, 1 μm or more and 100 μm or less, 5 μm or more and 50 μm or less, or 10 μm or more and 30 μm or less.

The negative electrode active material 21 provided in the second internal electrode 20 is not particularly limited as long as it functions as a negative electrode active material, but it is preferable that it is a negative electrode active material that operates at an average potential of 2 V vs. Li/Li⁺ or less, for example. An example is such as TiO₂, Ti—Nb—Ta—O based compounds, Al—Nb—Ta—O based compounds, Al—Nb—Hf—Ta—O based compounds, or the like. When such negative electrode active material is combined with a positive electrode active material having an operating potential of 4.7 V vs. Li/Li⁺ or higher, the operating voltage of the all solid battery 100 can be increased.

The solid electrolyte 22 in the second internal electrode 20 is preferably, but not limited to, a phosphate-based solid electrolyte having a NASICON structure. This is because phosphate-based solid electrolytes having a NASICON structure have the properties of a wide potential window on the high potential side and high atmospheric stability. The solid electrolyte 22 can be, for example, the same as the main solid electrolyte of the solid electrolyte layer 30.

If the average grain size of the solid electrolyte 22 in the second internal electrode 20 is small, the dispersion state of the electrode paste before firing becomes unstable, making it difficult to obtain a dense coating film, and the reactivity during heat treatment of the all solid battery 100 increases, making it easier for interdiffusion reactions to occur, which is not preferable. Therefore, it is preferable to set a lower limit on the average grain size of the solid electrolyte 22 in the second internal electrode 20. In this embodiment, the average grain size of the solid electrolyte 22 in the second internal electrode 20 is preferably 0.1 μm or more, more preferably 0.2 μm or more, and even more preferably 0.5 μm or more.

On the other hand, if the average grain size of the solid electrolyte 22 in the second internal electrode 20 is large, it is not preferable because a high temperature is required for sintering and densification. Therefore, it is preferable to set an upper limit on the average grain size of the solid electrolyte 22 in the second internal electrode 20. In this embodiment, the average grain size of the solid electrolyte 22 in the second internal electrode 20 is preferably 10.0 μm or less, more preferably 7.0 μm or less, and even more preferably 5.0 μm or less.

If the content of the solid electrolyte 22 in the second internal electrode 20 is small, it is not preferable because the ion conduction path is not secured and the internal resistance becomes high. Therefore, it is preferable to set a lower limit on the content of the solid electrolyte 22. In this embodiment, the area occupancy ratio of the solid electrolyte 22 in the cross section of the second internal electrode 20 is preferably 15% or more, more preferably 20% or more, and even more preferably 25% or more.

If the content of solid electrolyte 22 in the second internal electrode 20 is high, it is not preferable because the active material filling amount is not increased and the capacity decreases. Therefore, it is preferable to set an upper limit on the content of solid electrolyte 22. In this embodiment, the area occupancy ratio of the solid electrolyte 22 in the cross section of the second internal electrode 20 is preferably 75% or less, more preferably 70% or less, and even more preferably 65% or less.

The thickness of each of the second internal electrodes 20 is, for example, 1 μm or more and 100 μm or less, 5 μm or more and 50 μm or less, or 10 μm or more and 30 μm or less.

The first internal electrode 10 and the second internal electrode 20 may include a conductive material (conductive assistant). A carbon material or the like may be used as the conductive additive. A metal may be used as the conductive additive. Examples of the metal of the conductive additive include Pd, Ni, Cu, Fe, or alloys containing these.

The average grain size of the electrode active material and the solid electrolyte in the first internal electrode 10 and the second internal electrode 20 can be measured by the following method. First, a cross-section polisher (CP) or the like is used to process the internal electrode from a direction approximately perpendicular to the stack thickness direction of the all solid battery. Next, for example, a scanning electron microscope (manufactured by Hitachi High-Technologies Corporation, model: SU-7000) is used for observation at an accelerating voltage of 5 kV, and the electrode active material grains and solid electrolyte grain regions in the internal electrode are identified by SEM images at a magnification of 10,000 times and elemental analysis by SEM-EDS. Ten or more locations are observed, and for the identified electrode active material grains and solid electrolyte grains, grains that exist in isolation from other grains are selected to obtain at least ten or more grain sizes. Next, the grain area of each selected grain is measured using image analysis software, and the circle equivalent diameter (Heywood diameter) is measured from the grain area. The median diameter (D50 value) of each grain is calculated from the grain size distribution obtained by plotting the grain size on the x-axis and the frequency on the y-axis, and can be defined as the average grain size of each grain.

The area occupancy rate of the electrode active material and the solid electrolyte in the first internal electrode 10 and the second internal electrode 20 can be measured by the following method. First, a cross-section polisher (CP) or the like is used to process the internal electrode in a direction approximately perpendicular to the thickness direction of the stack of the all solid battery. Next, for example, a scanning electron microscope (manufactured by Hitachi High-Tech Corporation, model: SU-7000) is used to observe at an accelerating voltage of 5 kV, and 10 locations are obtained from the internal electrode at the same magnification, along with elemental analysis by SEM-EDS. Using image analysis software, the areas of the electrode active material and solid electrolyte that occupy the acquired image can be identified, and the arithmetic average value of each area occupancy ratio can be calculated.

The thickness of each layer can be determined by using a cross-section polisher (CP) or the like to cut a cross section from a direction approximately perpendicular to the stack thickness direction of the solid-state battery, observing the cross section at an accelerating voltage of 5 kV using, for example, a scanning electron microscope (manufactured by Hitachi High-Tech Corporation, model: SU-7000), measuring backscattered electron images and elemental analysis by SEM-EDS at 10 points to distinguish the interface between each layer, and calculating the arithmetic average value of the 10 points on each layer.

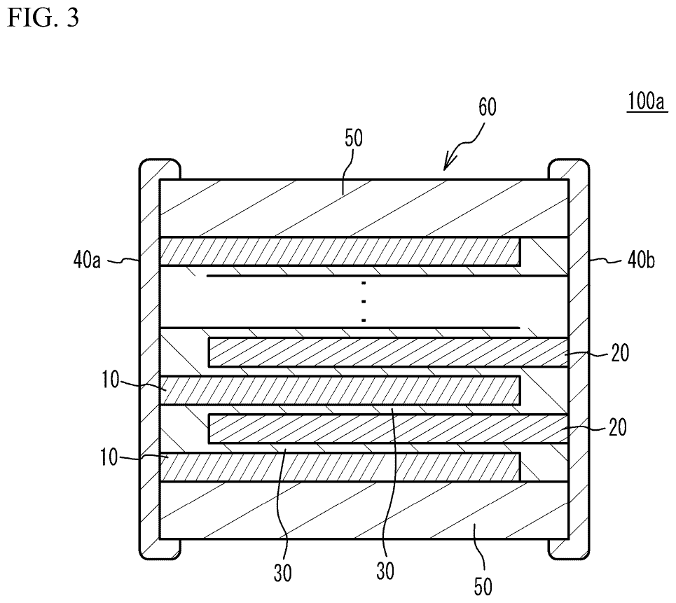

(Stack type all solid battery) FIG. 3 is a schematic partial cross-sectional view of a stacked all solid battery 100a in which a plurality of battery units are stacked. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In the following description, the same numeral is added to each member that has the same composition range, the same thickness range and the same particle distribution range as that of the all solid battery 100. And, a detail explanation of the same member is omitted.

In the all solid battery 100a, the plurality of first internal electrodes 10 and the plurality of second internal electrodes 20 are alternately stacked with the solid electrolyte layers 30 in between. The edges of the plurality of first internal electrodes 10 are exposed to the first end face of the multilayer chip 60 and are not exposed to the second end face. The edges of the plurality of second internal electrodes 20 are exposed to the second end face of the multilayer chip 60 and are not exposed to the first end face. Thereby, the first internal electrode 10 and the second internal electrode 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper surface of the multilayer structure of the first internal electrode 10, the solid electrolyte layer 30, and the second internal electrode 20 (in the example of FIG. 3, the upper surface of the uppermost first internal electrode 10). Further, the cover layer 50 is also stacked on the lower surface of the multilayer structure (in the example of FIG. 3, the lower surface of the lowermost first internal electrode 10). The cover layer 50 is mainly composed of an inorganic material (for example, Al₂O₃, ZrO₂, TiO₂ or the like) containing Al, Zr, Ti or the like. The cover layer 50 may contain the main component of the solid electrolyte layer 30 as a main component. The cover layer 50 is a sintered body.

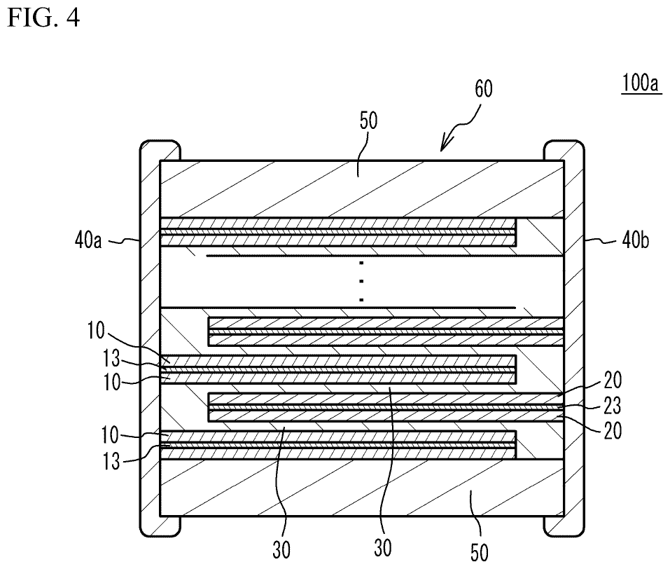

Each of the first internal electrode 10 and the second internal electrode 20 may include a current collector layer. For example, as illustrated in FIG. 4, a first current collector layer 13 may be provided within the first internal electrode 10. Further, a second current collector layer 23 may be provided within the second internal electrode 20. The first current collector layer 13 and the second current collector layer 23 have a conductive material as a main component. For example, metal, carbon, or the like can be used as the conductive material for the first current collector layer 13 and the second current collector layer 23. By connecting the first current collector layer 13 to the first external electrode 40a and connecting the second current collector layer 23 to the second external electrode 40b, current collection efficiency is improved.

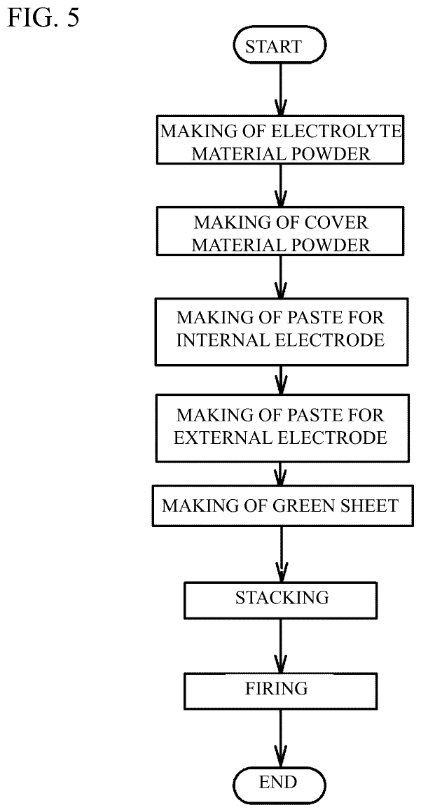

A description will be given of a manufacturing method of the all solid battery 100a described on the basis of FIG. 3. FIG. 5 illustrates a flowchart of the manufacturing method of the all solid battery 100a.

(Making process of raw material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ¢.

(Making process of raw material powder for cover layer) A raw material powder of ceramics for the cover layer 50 is made. For example, it is possible to make the raw material powder for the cover layer, by mixing raw material and additives and using solid phase synthesis method or the like. By dry-pulverizing the obtained raw material powder, it is possible to adjust the obtained material powder to a desired average particle size. For example, the particles are adjusted to a desired average particle size using a planetary ball mill using ZrO₂ balls of 5 mm diameter. When the solid electrolyte layer 30 and the cover layer 50 have the same composition, the raw material powder for the solid electrolyte layer can be used instead.

(Making process for internal electrode paste) Next, internal electrode pastes for making the first internal electrode 10 and the second internal electrode 20 described above are separately made. For example, the internal electrode paste can be obtained by uniformly dispersing a conductive additive, an electrode active material, a solid electrolyte material, a sintering assistant, a binder, a plasticizer, and the like in water or an organic solvent. The above-mentioned solid electrolyte paste may be used as the solid electrolyte material. A carbon material or the like may be used as the conductive additive. A metal may be used as the conductive assistant. An example of the metal of the conductive additive is such as Pd, Ni, Cu, Fe, or alloys containing these. Pd, Ni, Cu, Fe, alloys containing these, and various carbon materials may also be used.

The powder material of the positive electrode active material 11 described above is used as the electrode active material contained in the second internal electrode 20.

The sintering assistant includes one or more of glass components such as Li—B—O-based compound, Li—Si—O-based compound, Li—C—O-based compound, Li—S—O-based compound and Li—P—O-based compound.

(Making process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

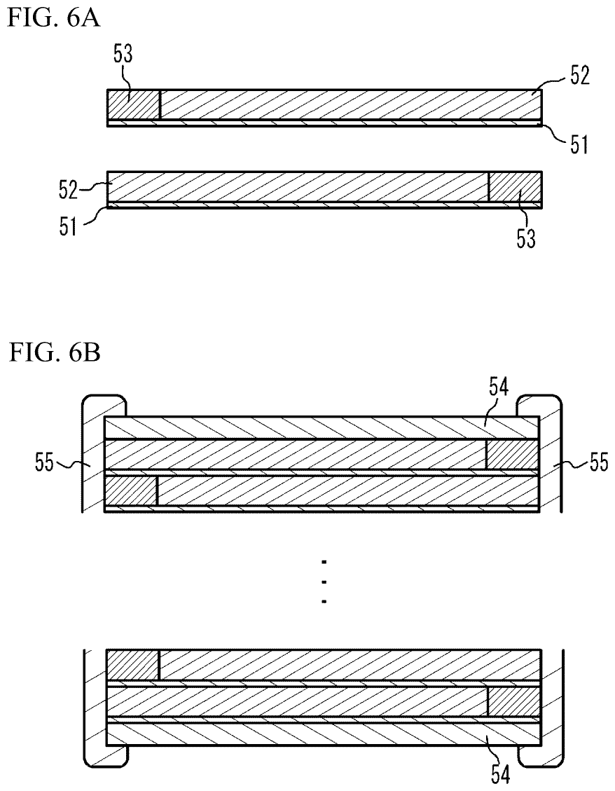

(Stacking process) As illustrated in FIG. 6A, an internal electrode paste 52 is printed on one side of the solid electrolyte green sheet 51. A reverse pattern 53 is printed on the peripheral area of the solid electrolyte green sheet 51 where the internal electrode paste 52 is not printed. The same material for the solid electrolyte green sheet 51 can be used as the reverse pattern 53. The solid electrolyte green sheet 51 after the printing can be used as a stack unit. The plurality of solid electrolyte green sheets 51 are stacked so as to be alternately shifted. As illustrated in FIG. 6B, a multilayer structure is obtained by pressing a cover sheet 54 from above and below in the stacking direction. In this case, in the multilayer structure, the internal electrode paste 52 for the first internal electrode 10 is exposed on one end surface, and the internal electrode paste 52 for the second internal electrode 20 is exposed on the other end surface. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an eternal electrode paste 55 is applied to two end faces of the multilayer structure by dipping or the like and is dried. Thus, a compact for forming the all solid battery 100a is obtained.

(Firing process) Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the all solid battery 100a is formed.

By sequentially stacking the internal electrode paste, the current collector paste containing a conductive material, and the internal electrode paste, a current collector layer can be formed in the first internal electrode 10 and the second internal electrode 20.

According to the manufacturing method according to this embodiment, a powder material of the positive electrode active material 11 is used in the internal electrode paste for producing the first internal electrode 10, so that the first internal electrode 10 containing the positive electrode active material 11 can be made. This makes it possible to manufacture an all solid battery with excellent cycle characteristics. Although a powder material of the same composition as the positive electrode active material 11 may be used, the positive electrode active material 11 may be synthesized by mixing each material for synthesizing the positive electrode active material 11 (for example, a Co-containing phosphate such as LiCoPO₄ or NaCoPO₄ with an oxide such as Si, Mg, Fe, Mn, Zn, or Ni, and then performing a heat treatment. Alternatively, each material for synthesizing the positive electrode active material 11 may be included in the internal electrode paste for producing the first internal electrode 10, and the positive electrode active material 11 may be synthesized during the firing process.

### EXAMPLES

All solid batteries were fabricated according to the above-mentioned embodiments and their characteristics were examined.

(Example 1) Li_{0.99}Co_{1.01}P_{0.99}Si_{0.01}O₄ positive electrode active material with an average particle size adjusted to 0.20 μm was used for the positive electrode. Li—Al—Co—Ge—PO₄-based NASICON-type phosphate-based glass solid electrolyte was used for the solid electrolyte. A positive electrode paste with a weight ratio of the positive electrode active material, a carbon conductive additive, and the solid electrolyte of 45:10:45 was made and printed on a solid electrolyte sheet.

TiTa_{1.5}Nb_{0.5}O₇ negative electrode with an average particle size adjusted to 1.00 μm was used for the negative electrode. Li—Al—Ge—PO₄ glass was used for the solid electrolyte. A negative electrode paste with a weight ratio of the negative electrode active material, a carbon conductive assistant, and the solid electrolyte of 35:10:55 was prepared and printed on another solid electrolyte sheet.

The printed positive electrode sheet piece and the printed negative electrode sheet piece were stacked together with a sheet piece for a reference electrode, and a molded body was produced by press molding. The molded body produced was fired multiple times in a specified environment and temperature to produce an all solid battery with a reference electrode.

(Example 2) An all solid battery was fabricated in the same manner as in Example 1, except that a Li_{0.98}Co_{1.02}P_{0.98}Si_{0.02}O₄ positive electrode active material with an average particle size adjusted to 0.2 μm was used for the positive electrode.

(Example 3) An all solid battery was fabricated in the same manner as in Example 1, except that Li_{0.95}Co_{1.05}P_{0.95}Si_{0.05}O₄ positive electrode active material with an average particle size adjusted to 0.2 μm was used for the positive electrode.

(Example 4) An all solid battery was fabricated in the same manner as in Example 1, except that Li_{0.98}Co_{0.82}Ni_{0.2}P_{0.98}Si_{0.02}O₄ positive electrode active material with an average particle size adjusted to 0.2 μm was used for the positive electrode.

(Example 5) An all solid battery was fabricated in the same manner as in Example 1, except that Li_{0.97}Co_{0.88}Ni_{0.15}P_{0.97}Si_{0.03}O₄ positive electrode active material with an average particle size adjusted to 0.2 μm was used for the positive electrode.

(Example 6) An all solid battery was fabricated in the same manner as in Example 1, except that Li_{0.975}Co_{0.875}Ni_{0.1}Zn_{0.05}P_{0.975}Si_{0.025}O₄ positive electrode active material with an average particle size adjusted to 0.2 μm was used for the positive electrode.

(Comparative Example 1) An all solid battery was fabricated and evaluated in the same manner as in Example 1, except that LiCoPO₄ positive electrode active material with an average particle size adjusted to 0.2 μm was used for the positive electrode.

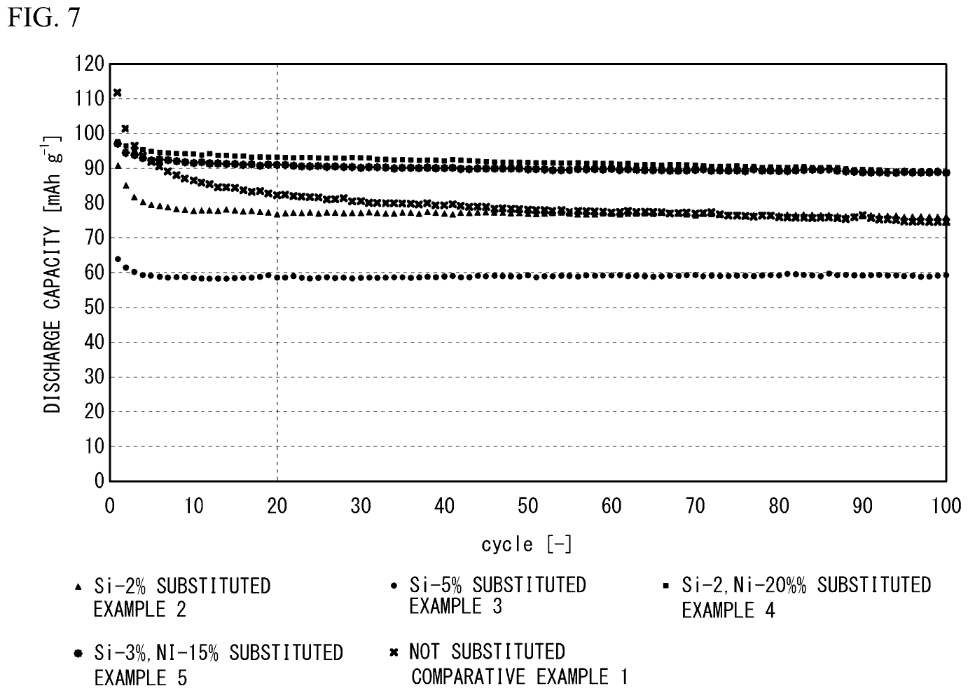

(Cycle characteristics) Next, the discharge capacity (mAh/g) after repeated charging and discharging was measured for each of Examples 1 to 6 and Comparative Example 1. The charge and discharge test was performed in a thermostatic chamber at 25° C. with a current of 0.2C rate and a constant current charge and discharge test with a positive electrode potential in the range of 4.30V to 5.05V vs Li/Lit. The results are shown in FIG. 7 and Table 1.

The initial discharge capacity was 97.19 mAh/g for Example 1, 90.68 mAh/g for Example 2, 64.11 mAh/g for Example 3, 97.72 mAh/g for Example 4, 97.17 mAh/g for Example 5, 120.09 mAh/g for Example 6, and 111.7 mAh/g for Comparative Example 1. The discharge capacity retention rate after 100 cycles based on the initial discharge capacity was 67.50% in Example 1, 83.93% in Example 2, 92.61% in Example 3, 91.09% in Example 4, 91.34% in Example 5, 80.84% in Example 6, and 66.84% in Comparative Example 1. Thus, the discharge capacity retention rates of Examples 1 to 6 were maintained higher than those of Comparative Example 1.

TABLE 1

| | POSITIVE ELECTRODE | | NEGATIVE ELECTRODE | | | DUSCHARGE |
|---|---|---|---|---|---|---|
| | AVERAGE | | AVERAGE | | INITIAL | CAPACITY |
| | PARTICLE | | PARTICLE | | DISCHARGE | RETENTION |
| | SIZE | | SIZE | ACTIVE | CAPACITY | RATE |
| | (μm) | ACTIVE MATERIAL | (μm) | MATERIAL | (mAh/g) | (%) |
| EXAMPLE 1 | 0.2 | Li_{0.99}Co_{1.01}P_{0.99}Si_{0.01}O₄ | 1.0 | TiTa₂₋ₓNbₓO_{7-δ} | 97.19 | 67.50 |
| EXAMPLE 2 | | Li_{0.98}Co_{1.02}P_{0.98}Si_{0.02}O₄ | | | 90.68 | 83.93 |
| EXAMPLE 3 | | Li_{0.95}Co_{1.05}P_{0.95}Si_{0.05}O₄ | | | 64.11 | 92.61 |
| EXAMPLE 4 | | Li_{0.98}Co_{0.82}Ni_{0.2}P_{0.98}Si_{0.02}O₄ | | | 97.72 | 91.09 |
| EXAMPLE 5 | | Li_{0.97}Co_{0.88}Ni_{0.15}P_{0.97}Si_{0.03}O₄ | | | 97.17 | 91.34 |
| EXAMPLE 6 | | Li_{0.975}Co_{0.875}Ni_{0.1}Zn_{0.05}P_{0.975}Si_{0.025}O₄ | | | 120.09 | 80.84 |
| COMAPARATIVE | | LiCoPO₄ | | | 111.7 | 66.84 |
| EXAMPLE 1 | | | | | | |

As described above, the discharge capacity retention rates of Examples 1 to 6 were higher than that of Comparative Example 1. This is believed to be because the use of a positive electrode active material of an alkali metal phosphate containing Co, in which Si is solid-dissolved, suppresses volumetric changes during charging and discharging.

Although the embodiments of the present invention have been described in detail, it is to be understood that the various change, substitutions, and alterations could be made hereto without departing from the spirit and scope of the invention.

What is claimed is:

1. A positive electrode active material comprising:
an alkali metal phosphate containing Co,
wherein Si is solid-solved in the phosphate.

2. The positive electrode active material as claimed in claim 1,
wherein in the phosphate, a part of a P site is substituted with Si.

3. The positive electrode active material as claimed in claim 1,
wherein in the phosphate, a part of a Co site is substituted with at least one element selected from Mg, Fe, Mn, Zn, or Ni.

4. The positive electrode active material as claimed in claim 1,
wherein the phosphate is represented by a general formula M_{1-y}CO_{1-x+y}M′ₓP_{1-y}Si_{y}O₄ (0≤x≤1, 0<y<1),
wherein M is an alkali metal, and
wherein M′ is at least one element selected from a group consisting of Mg, Mn, Fe, Zn, and Ni.

5. The positive electrode active material as claimed in claim 4,
wherein the M is Li.

6. The positive electrode active material as claimed in claim 4,
wherein in the M_{1-y}CO_{1-x+y}M′ₓP_{1-y}Si_{y}O₄, 0<y≤0.1 is satisfied.

7. The positive electrode active material as claimed in claim 4,
wherein in the M_{1-y}Co_{1-x+y}M′ₓP_{1-y}Si_{y}O₄, 0.01≤y≤0.05 is satisfied.

8. The positive electrode active material as claimed in claim 1,
wherein the phosphate has an olivine structure.

9. A positive electrode active material comprising:
an alkali metal phosphate containing Co,
wherein, when the phosphate is analyzed by XRD, a peak of a substance expressed by a general formula M_{1-y}Co_{1-x+y}M′ₓPO₄ (0≤x≤1, 0<y<1) appears,
wherein M is an alkali metal, and
wherein M′ is at least one element selected from Mg, Fe, Mn, Zn, or Ni.

10. An all solid battery comprising:
a positive electrode layer including a positive electrode active material of claim 1,
a negative electrode layer, and
a solid electrolyte layer between the positive electrode layer and the negative electrode layer.

11. The all solid battery as claimed in claim 10,
wherein an average grain size of the positive electrode active material in the positive electrode layer is 0.05 μm or more and 5.00 μm or less.

12. The all solid battery as claimed in claim 10,
wherein an occupancy ratio of the positive electrode active material in a cross section of the positive electrode layer is 40% or more and 75% or less.

13. The all solid battery as claimed in claim 10,
wherein the positive electrode layer includes a phosphate-based solid electrolyte having a NASICON structure.

14. The all solid battery as claimed in claim 13,
wherein an average grain size of the phosphate-based solid electrolyte in the positive electrode layer is 0.1 μm or more and 10.0 μm or less.

15. The all solid battery as claimed in claim 13,
wherein an occupancy ratio of the phosphate-based solid electrolyte in the positive electrode layer is 20% or more and 75% or less.

16. An all solid battery comprising:
a positive electrode layer including a positive electrode active material of claim 9,
a negative electrode layer, and
a solid electrolyte layer between the positive electrode layer and the negative electrode layer.

17. The all solid battery as claimed in claim 16,
wherein an average grain size of the positive electrode active material in the positive electrode layer is 0.05 μm or more and 5.00 μm or less.

18. The all solid battery as claimed in claim 16,
wherein an occupancy ratio of the positive electrode active material in a cross section of the positive electrode layer is 40% or more and 75% or less.

19. The all solid battery as claimed in claim 16,
wherein the positive electrode layer includes a phosphate-based solid electrolyte having a NASICON structure.

20. The all solid battery as claimed in claim 16,
wherein a thickness of the positive electrode layer is 1 μm or more and 100 μm or less.
